(19) United States
(12) Patent Application Publication
(10) Pub. No.: US 2014/0210861 A1
(43) Pub. Date: Jul. 31, 2014

(54) INFORMATION DISPLAY DEVICE, INFORMATION DISPLAY METHOD, AND COMPUTER PROGRAM PRODUCT

(71) Applicant: Sachiko ABE, Kanagawa (JP)

(72) Inventor: Sachiko ABE, Kanagawa (JP)

(21) Appl. No.: 14/151,157

(22) Filed: Jan. 9, 2014

(30) Foreign Application Priority Data
Jan. 28, 2013 (JP) 2013-013584

(51) Int. Cl. G06T 3/40

(52) U.S. Cl. CPC G06T 3/40
USPC 345/660

(57) ABSTRACT

An information display device includes: a selecting condition acquisition unit that externally acquires selecting condition information including a selecting condition for selecting an image file; a selection unit that selects at least one image file out of a plurality of image files stored in an external storage device on the basis of the selecting condition information; a reduced image generating unit that generates a reduced image representing the at least one selected image file; and a display control unit that causes the reduced image of each of the at least one selected image file to be displayed.

### CROSS-REFERENCE TO RELATED APPLICATIONS

The present application claims priority to and incorporates by reference the entire contents of Japanese Patent Application No. 2013-013584 filed in Japan on Jan. 28, 2013.

### BACKGROUND OF THE INVENTION

1. Field of the Invention

The present invention relates to an information display device, an information display method, and a computer program that display a reduced image of an image file.

2. Description of the Related Art

Information processing terminals display reduced images called thumbnails or the like showing representative images of image files in addition to characters indicating names of the files when displaying search results of the image files in some cases. With the reduced images, the information processing terminals make it possible for users to intuitively recognize the presence and contents of the image files.

When detecting a large number of image files, the information processing terminals, however, take a long time to display the reduced images due to an increase in the amount of processing for displaying the reduced images. In addition, users take a long time to find their desired image files from the displayed reduced images.

Japanese Laid-open Patent Publication No. 2008-146177 describes a method of narrowing down the number of reduced images to be displayed with a condition preliminarily set in an information processing terminal, thereby reducing a load of display processing of the reduced images. This method can reduce a processing load of the information processing terminal and a user can readily find out the desired image file because a limited number of reduced images are displayed.

In the method described in Japanese Laid-open Patent Publication No. 2008-146177, the condition for selecting a reduced image is preliminarily set in the information processing terminal. Thus, this method may not appropriately select a reduced image to be displayed when a large number of image files in a privately owned external storage device (e.g., a universal serial bus (USB) memory) are displayed in a shared device (e.g., a shared computer or projector).

In view of these circumstances, there is a need to provide an information display device, an information processing method, and a computer program product that display a selected reduced image that is selected appropriately.

### SUMMARY OF THE INVENTION

It is an object of the present invention to at least partially solve the problems in the conventional technology.

An information display device includes: a selecting condition acquisition unit that externally acquires selecting condition information including a selecting condition for selecting an image file; a selection unit that selects at least one image file out of a plurality of image files stored in an external storage device on the basis of the selecting condition information; a reduced image generating unit that generates a reduced image representing the at least one selected image file; and a display control unit that causes the reduced image of each of the at least one selected image file to be displayed.

An information display method includes: externally acquiring selecting condition information including a selecting condition for selecting an image file; selecting at least one image file out of a plurality of image files stored in an external storage device on the basis of the selecting condition information; generating a reduced image representing the at least one selected image file; and causing the reduced image of each of the at least one selected image file to be displayed.

A computer program product includes a non-transitory computer-usable medium having computer-readable program codes embodied in the medium. The program codes when executed cause a computer to function as: a selecting condition acquisition unit that externally acquires selecting condition information including a selecting condition for selecting an image file; a selection unit that selects at least one image file out of a plurality of image files stored in an external storage device on the basis of the selecting condition information; a reduced image generating unit that generates a reduced image representing the at least one selected image file; and a display control unit that causes the reduced image of each of the at least one selected image file to be displayed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a functional block structure of an information display system 10 according to an embodiment of the present invention;

FIG. 2 is a schematic diagram illustrating a functional block structure of the information display system 10 according to a modification of the embodiment;

FIG. 3 is a schematic diagram illustrating an example of attributes of an image file described in image information;

FIG. 4 is a schematic diagram illustrating a specific description example of the image information;

FIG. 5 is a schematic diagram illustrating a specific description example of selecting condition information;

FIG. 6 is a schematic diagram illustrating a processing flow performed by an information display device 30 according to the embodiment;

FIGS. 7A and 7B are schematic diagrams illustrating an example of the image information before and after selection when an author of the image file is specified as a selecting condition;

FIGS. 8A and 8B are schematic diagrams illustrating an example of the image information before and after selection when a creation time of the image file is specified as the selecting condition;

FIGS. 9A and 9B are schematic diagrams illustrating an example of the image information before and after selection when a size of the image file is specified as the selecting condition;

FIGS. 10A and 10B are schematic diagrams illustrating an example of the image information before and after selection when a type of the image file is specified as the selecting condition;

FIGS. 11A and 11B are schematic diagrams illustrating an example of the image information before and after selection when a name of the image file is specified as the selecting condition;

FIGS. 12A and 12B are schematic diagrams illustrating an example of the image information before and after selection when a storage location of the image file is specified as the selecting condition;

FIGS. 13A and 13B are schematic diagrams illustrating an example of the image information before and after selection when the author and the size of the image file are specified with an AND condition as the selecting condition;

FIG. 14 is a schematic diagram illustrating an example of a screen of a display unit 37 when the reduced images of all the image files in an external storage device 20 are displayed; and

FIG. 15 is a schematic diagram illustrating an example of the screen of the display unit 37 when the reduced images of the image files selected out of the image files in the external storage device 20 on the basis of the selecting condition information are displayed.

### DETAILED DESCRIPTION OF THE PREFERRED EMBODIMENT

The following describes an embodiment of the present invention with reference to the accompanying drawings. The embodiment does not limit the invention.

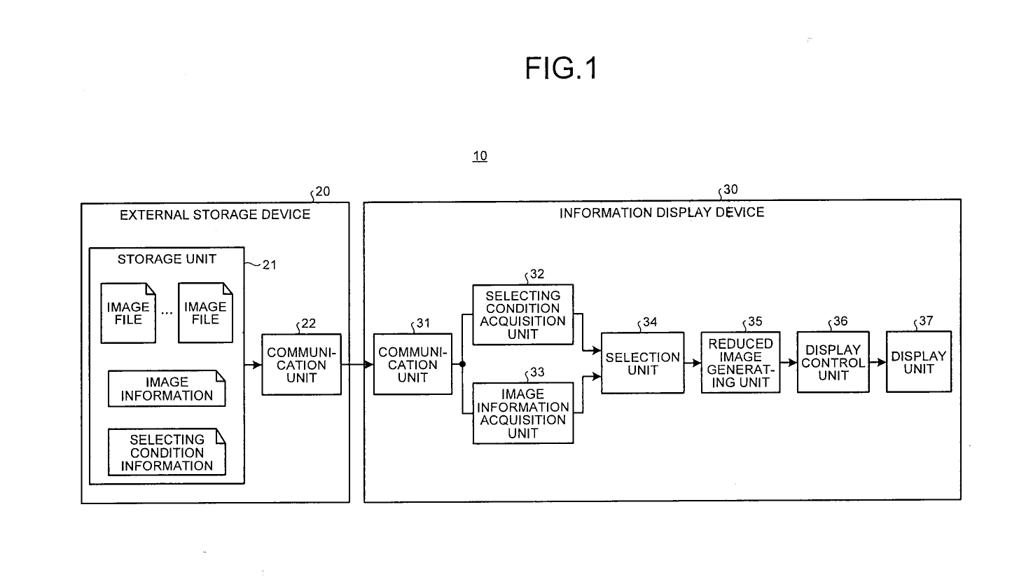

FIG. 1 is a schematic diagram illustrating a functional block structure of an information display system 10 according to the embodiment of the present invention. The information display system 10 includes an external storage device 20 and an information display device 30.

The external storage device 20 is a device for storing therein electronic data. The external storage device 20 is a universal serial bus (USB) memory capable of being carried by a user, for example. The external storage device 20 is attached to the information display device 30. The external storage device 20 functions as a storage device of the information display device 30 in a state where the external storage device 20 is attached to the information display device 30.

The external storage device 20 includes a storage unit 21 and a communication unit 22. The storage unit 21 stores therein a plurality of image files, image information, and selecting condition information. For example, the image file is a still image file. The image file may be a moving image file or a presentation data file.

The image information describes attributes of the respective image files stored in the storage unit 21. In the image information, the contents of the image information regarding an image file are updated every time a user newly creates or edits the image file, for example. The further detail of the image information is described later.

The selecting condition information includes a selecting condition for selecting the image file. The selecting condition information is prepared by the owner of the external storage device 20 in advance of attachment of the external storage device 20 to the information display device 30, for example. The further detail of the selecting condition information is described later.

The communication unit 22 is a circuit that exchanges data in the storage unit 21 between the external storage device 20 and the information display device 30. The communication unit 22 is a USB interface circuit, for example.

The information display device 30 is a device for displaying the electronic data. The information display device 30 is a projector, for example. The information display device 30 may be a computer or a compact information terminal such as a tablet information terminal. The information display device 30 uses the external storage device 20 as the storage device upon attachment of the external storage device 20 thereto.

The information display device 30 includes a communication unit 31, a selecting condition acquisition unit 32, an image information acquisition unit 33, a selection unit 34, a reduced image generating unit 35, a display control unit 36, and a display unit 37. The communication unit 31 is a circuit that exchanges data in the storage unit 21 between the information display device 30 and the external storage device 20. The communication unit 31 is a USB interface circuit, for example.

The selecting condition acquisition unit 32 acquires the selecting condition information from the external storage device 20 through the communication units 22 and 31. The selecting condition acquisition unit 32 automatically acquires the selecting condition information upon attachment of the external storage device 20 to the information display device 30, for example. The image information acquisition unit 33 acquires the image information from the external storage device 20 through the communication units 22 and 31. The image information acquisition unit 33 automatically acquires the image information upon attachment of the external storage device 20 to the information display device 30, for example.

The selection unit 34 selects at least one image file out of the multiple image files stored in the external storage device 20 on the basis of the selecting condition information acquired by the selecting condition acquisition unit 32 and the image information acquired by the image information acquisition unit 33. The reduced image generating unit 35 generates a reduced image that represents each of at least one image file selected by the selection unit 34.

The reduced image generating unit 35 generates the reduced image by reducing resolution of a still image when the image file is a still image file, for example. When the image file is a moving image file or a presentation data file, the reduced image generating unit 35 generates the reduced image by converting the resolution of a frame or a page at a predetermined position (e.g., the head frame or the head page) into a certain resolution, for example.

The display control unit 36 causes the display unit 37 to display the reduced image generated by the reduced image generating unit 35. The display unit 37 displays the reduced image in accordance with the control performed by the display control unit 36. The selecting condition acquisition unit 32, the image information acquisition unit 33, the selection unit 34, the reduced image generating unit 35, and the display control unit 36 included in the information display device 30 may be achieved by causing a processing device such as a central processing unit (CPU) to execute a computer program, i.e., by software. They may be achieved by hardware such as an integrated circuit (IC) or by both the software and the hardware.

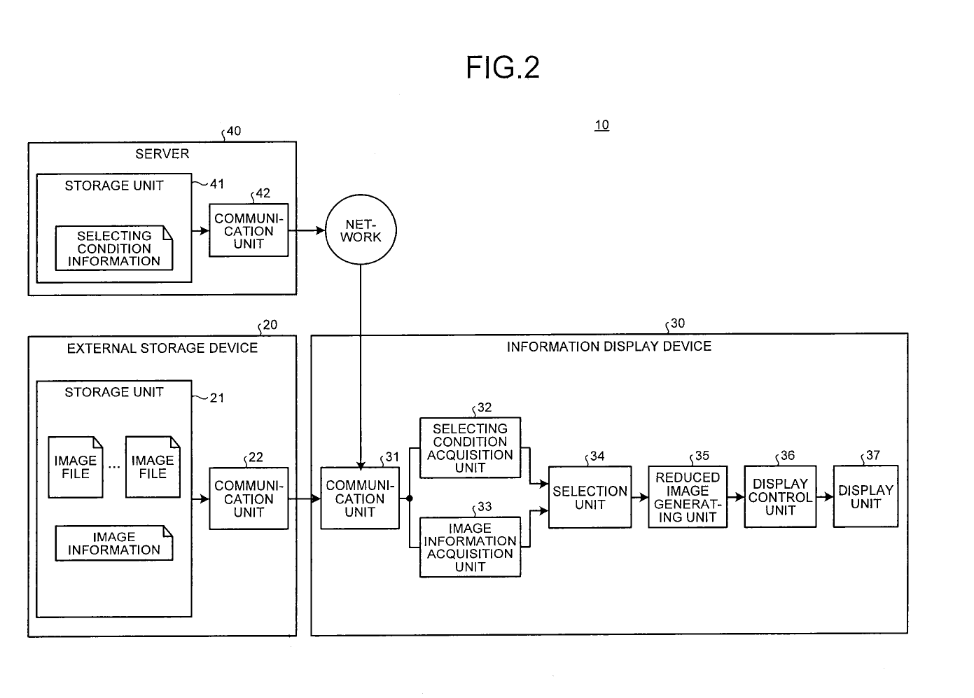

FIG. 2 is a schematic diagram illustrating a functional block structure of the information display system 10 according to a modification. The information display system 10 may have the structure illustrated in FIG. 2 instead of that illustrated in FIG. 1. The information display system 10 structured as illustrated in FIG. 2 includes the external storage device 20, the information display device 30, and a server 40.

The external storage device 20 illustrated in FIG. 2 has the same function and structure as those of the external storage device 20 illustrated in FIG. 1, but differs from the external storage device 20 illustrated in FIG. 1 in that the storage unit 21 stores therein no selecting condition information. The server 40 is the storage device different from the external storage device 20 and coupled to the information display device 30 through a network, for example. The server 40 includes a storage unit 41 and a communication unit 42. The storage unit 41 stores therein the selecting condition information including the selecting condition for selecting the image file. The communication unit 42 transmits the selecting condition information in the storage unit 41 to the information display device 30 through the network.

The selecting condition acquisition unit 32 of the information display system 10 in the modification acquires the selecting condition information from the server 40 when no selecting condition information is present in the external storage device 20 attached to the information display device 30. In this way, the information display system 10 illustrated in FIG. 2 allows the selecting condition information to be stored in a storage area other than the external storage device 20.

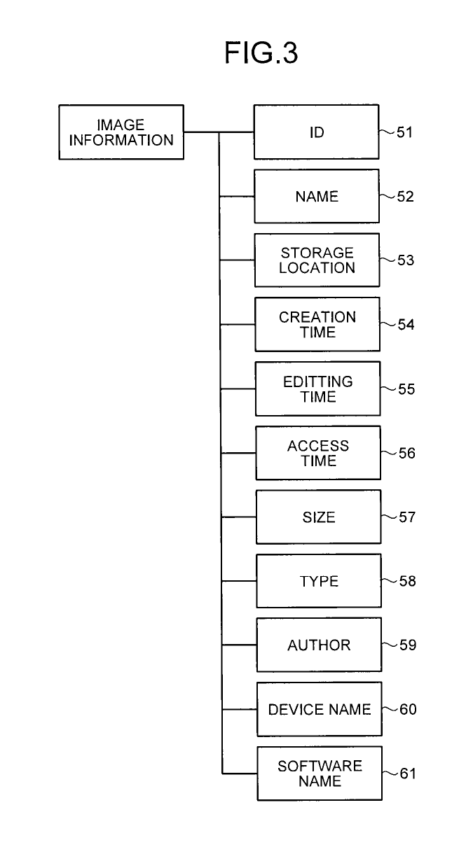

FIG. 3 is a schematic diagram illustrating an example of attributes of the image file described in the image information. The image information describes, as the attributes of the image file, an ID 51, a name 52, a storage location 53, a creation time 54, a last editing time 55, a last access time 56, a size 57, a type 58, an author 59, a device name 60, and a software name 61.

The ID 51 is a serial number of the image file stored in the external storage device 20. The name 52 is the name of the image file. The storage location 53 is the storage area of the image file in the external storage device 20.

The creation time 54 is the time when the image file is created. The last editing time 55 is the time when the image file is last edited. The last access time 56 is the time when the image file is last accessed. The size 57 is the size of the image file.

The type 58 is the file type of the image file. Examples of the file type include joint photographic experts group (JPEG) and moving picture experts group (MPEG). The author 59 is the name of a person who creates the image file. The device name 60 is the name of the device with which the image file and the image are created. The software name 61 is the name of software used in the last creation and editing of the image file.

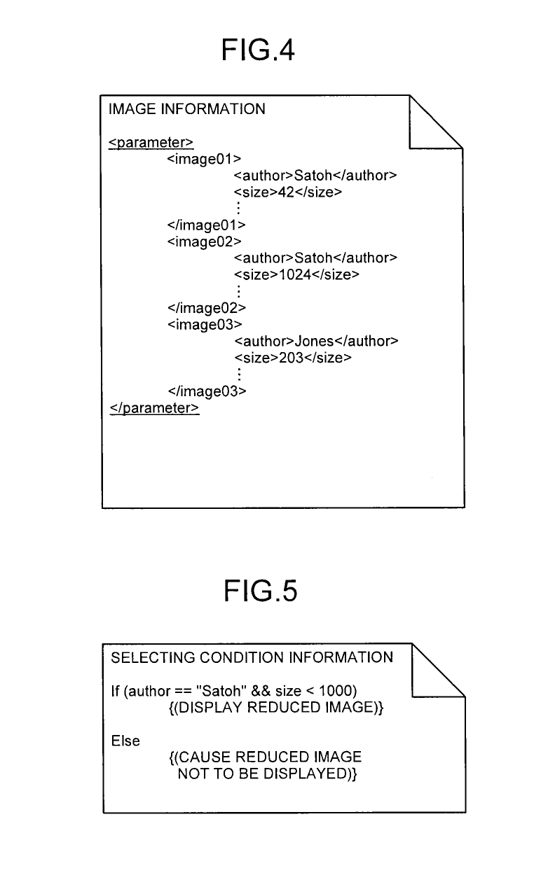

FIG. 4 is a schematic diagram illustrating a specific description example of the image information. The image information is written in a markup language as illustrated in FIG. 4, for example. The use of such image information enables the information display device 30 to interpret the content of the image information without using a special algorithm.

FIG. 5 is a schematic diagram illustrating a specific description example of the selecting condition information. The selecting condition information describes a selecting condition for selecting an image file having a specific attribute.

More specifically, the selecting condition information is written in program codes illustrated in FIG. 5. The selecting condition information includes a condition determination code in which a value or a range of the attribute of the image file is written, and a code indicating processing when the image file meets the condition (e.g., processing of displaying the reduced image) and processing when the image file does not meet the condition (e.g., processing of causing the reduced image not to be displayed). In this case, the condition determination code may be a code that causes determination to be executed in which values or ranges of a plurality of attributes are combined using a logical operation formula such as AND operation and/or OR operation.

The selection unit 34 substitutes the image information of each image file illustrated in FIG. 4 into the code illustrated in FIG. 5 as parameters. As a result, the selection unit 34 can determine whether the reduced image is displayed for each image file. In this way, the information display device 30 can perform processing according to the selecting condition without using a special algorithm.

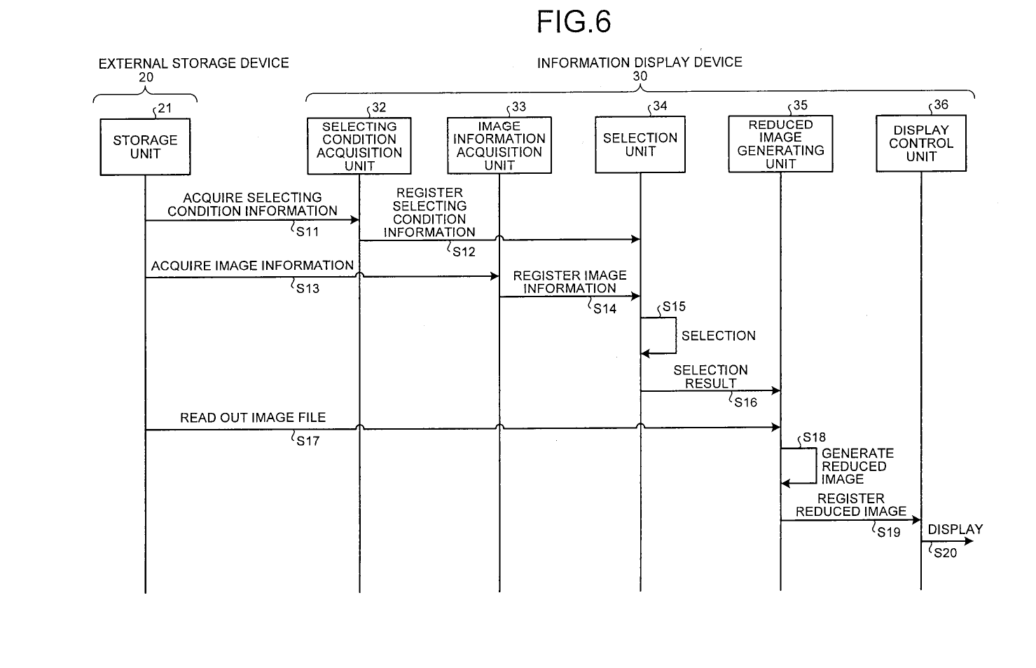

FIG. 6 is a schematic diagram illustrating a processing flow performed by the information display device 30 according to the embodiment. The information display device 30 performs the processing from step S11 to step S20 illustrated in FIG. 6 upon attachment of the external storage device 20 thereto.

At step S11, the selecting condition acquisition unit 32 acquires the selecting condition information from the storage unit 21 of the external storage device 20 through the communication units 22 and 31. When no selecting condition information is present in the external storage device 20, the selecting condition acquisition unit 32 acquires the selecting condition information from the storage unit 41 of the server 40 at a predetermined location in the network. At step S12, the selecting condition acquisition unit 32 registers the acquired selecting condition information to the selection unit 34.

At step S13, the image information acquisition unit 33 acquires the image information from the storage unit 21 of the external storage device 20 through the communication units 22 and 31. At step S14, the image information acquisition unit 33 registers the acquired image information to the selection unit 34.

At step S15, the selection unit 34 selects at least one image file having the attribute that meets the selecting condition, out of the image files stored in the external storage device 20 on the basis of the image information and the selecting condition information. At step S16, the selection unit 34 registers the selection result to the reduced image generating unit 35.

At step S17, the reduced image generating unit 35 reads out the selected image file from the storage unit 21 of the external storage device 20. At step S18, the reduced image generating unit 35 generates the reduced image from the read image file. The reduced image generating unit 35 may read out a preliminarily stored thumbnail and generate the reduced image when the thumbnail is preliminarily stored in the storage unit 21 as additional information of the image file.

At step S19, the reduced image generating unit 35 registers the generated reduced image to the display control unit 36. At step S20, the display control unit 36 causes the display unit 37 to display the registered reduced image thereon.

As described above, in the information display system 10 according to the embodiment, the information display device 30 acquires the selecting condition information externally, and displays the reduced image selected on the basis of the acquired selecting condition information. Thereby, the information display system 10 selects the image file, the reduced image of which is to be displayed, on the basis of the selecting condition information using an author or an editor of the image file, for example, thereby making it possible to display the reduced image that is appropriately selected.

Upon attachment of the external storage device 20 to the information display device 30, the selecting condition acquisition unit 32 may allow a user to directly input the selecting condition information or allow a user to edit the selecting condition information acquired from the external storage device 20. As a result, the information display device 30 can display the appropriate reduced image even if no selecting condition information is present or selecting condition information that includes a wrong selecting condition is stored in the external storage device 20, for example.

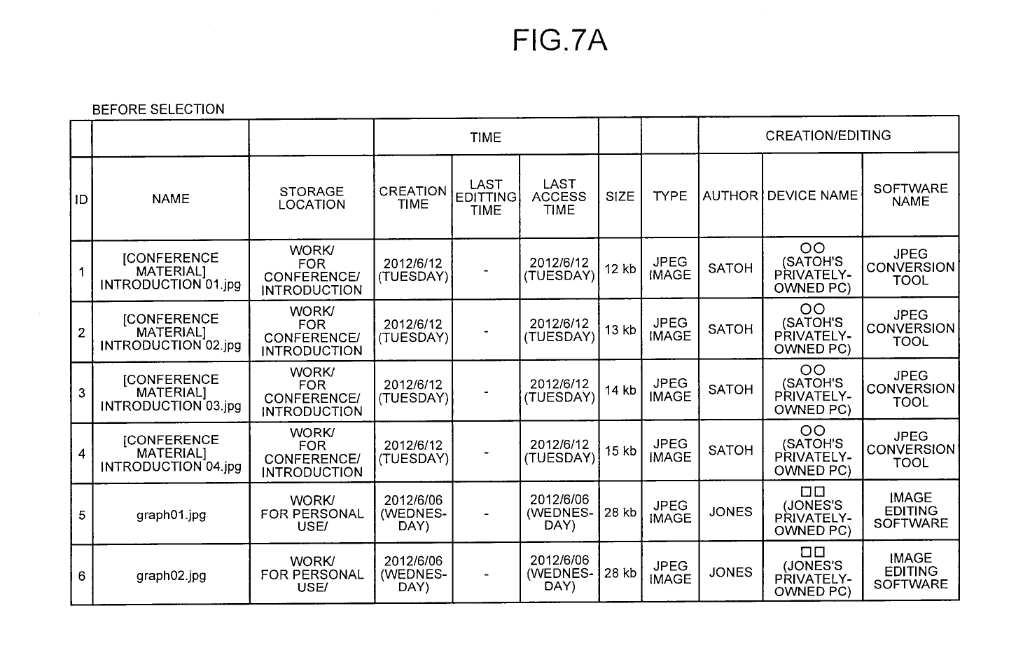

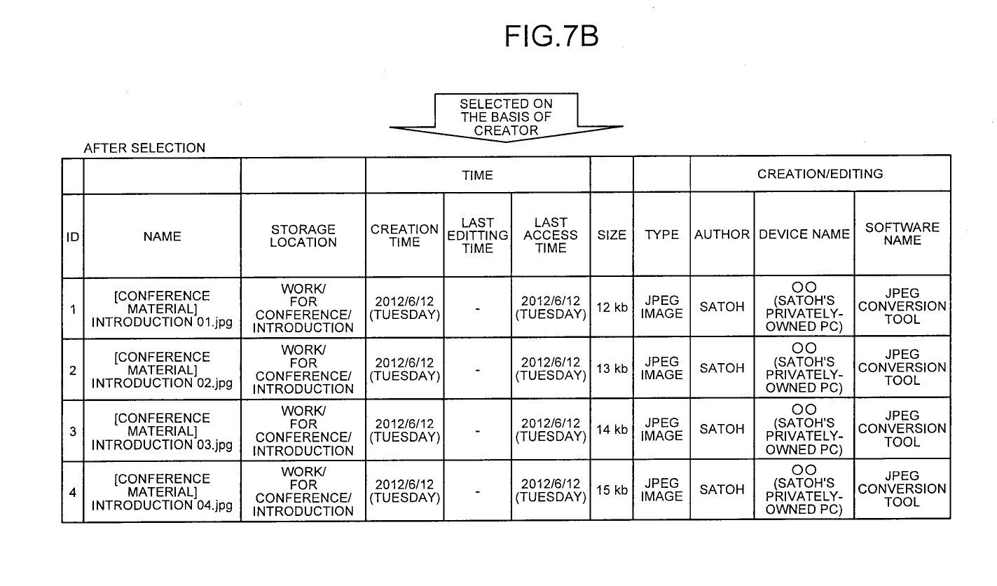

FIGS. 7A and 7B are schematic diagrams illustrating an example of the image information before and after selection when an author of the image file is specified as the selecting condition. In this example, the external storage device 20 stores therein six image files having respective attributes illustrated in the image information in the table in FIG. 7A. The selecting condition information describes the selecting condition under which the image file having the author of “Satoh” is extracted to display the reduced image.

In this case, the selection unit 34 selects at least one image file on the basis of the selecting condition information including the author of the image file as the selecting condition. More specifically, the selection unit 34 selects the image files meeting the condition that the author is “Satoh”, as illustrated in the table in FIG. 7B. Thereby, when a presenter gives a presentation while displaying an image file on a shared projector in a conference, for example, the information display device 30 enables the presenter to display only the image file created by the presenter on the projector as the reduced image.

The selecting condition information may describe a selecting condition under which the device name is extracted to display the reduced image. In this case, the information display device 30 can avoid displaying, on a shared projector or the like, the reduced image of a private image file created or edited by the presenter using a privately owned device.

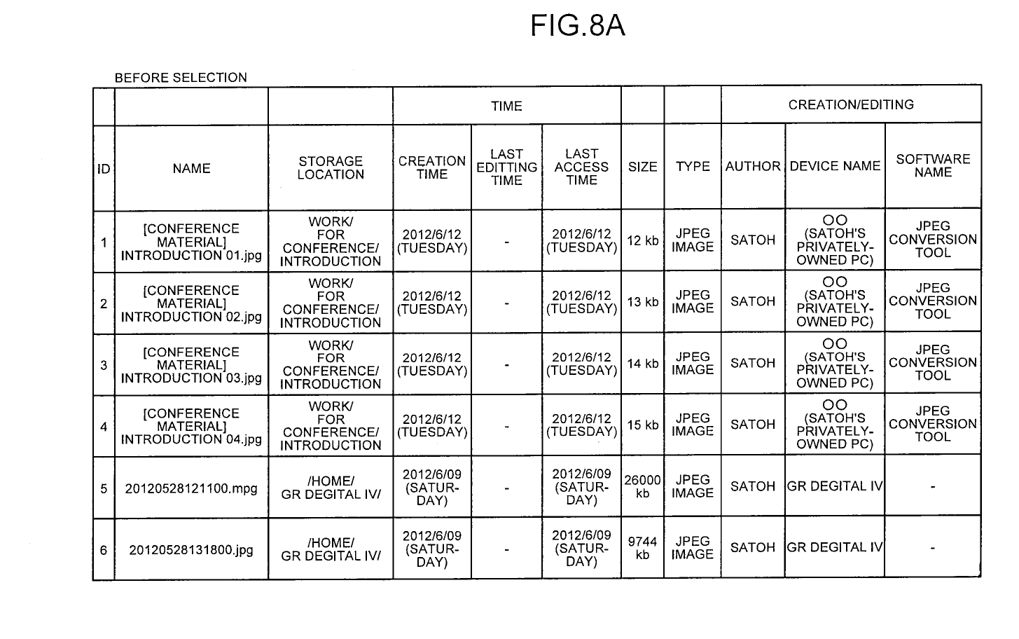

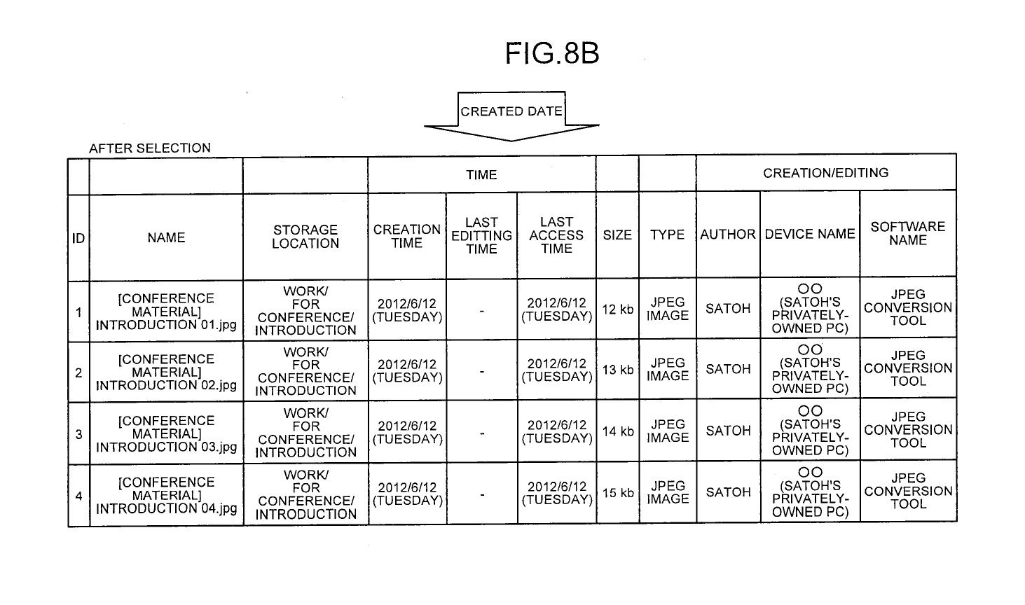

FIGS. 8A and 8B are schematic diagrams illustrating an example of the image information before and after selection when the creation time of the image file is specified as the selecting condition. In this example, the external storage device 20 stores therein six image files having respective attributes illustrated in the image information in the table in FIG. 8A. The selecting condition information describes the selecting condition under which the image file having the creation time of “a week day (from Monday to Friday)” is extracted to display the reduced image.

In this case, the selection unit 34 selects at least one image file on the basis of the selecting condition information including the creation time of the image file as the selecting condition. More specifically, the selection unit 34 selects the image files meeting the condition that the creation time is any day from Monday to Friday, as illustrated in the table in FIG. 8B. Thereby, when an image file is displayed on a shared projector in a conference, for example, the information display device 30 displays the reduced image of the image file created by the presenter during business hours of the company and can prohibit display of the reduced image of the image file created by the presenter outside his/her work on a non-working day, for example.

The selecting condition information may describe a selecting condition under which the image file having the last editing time or last access time of a week day is extracted and displayed. In this case, the information display device 30 can display only the reduced image of the image file edited or accessed during business hours on a shared projector, for example.

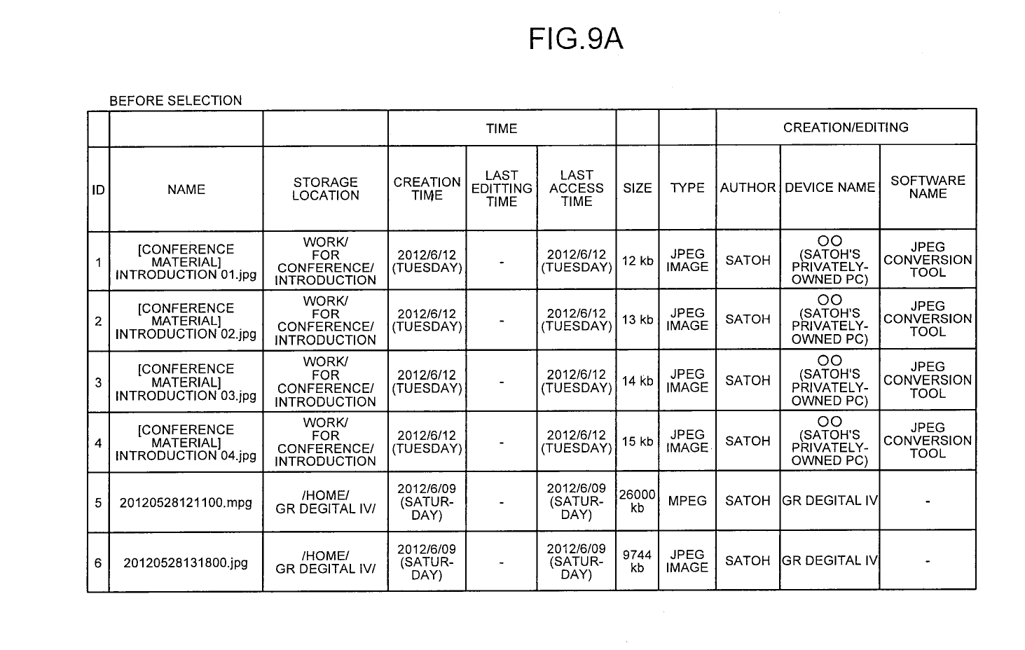

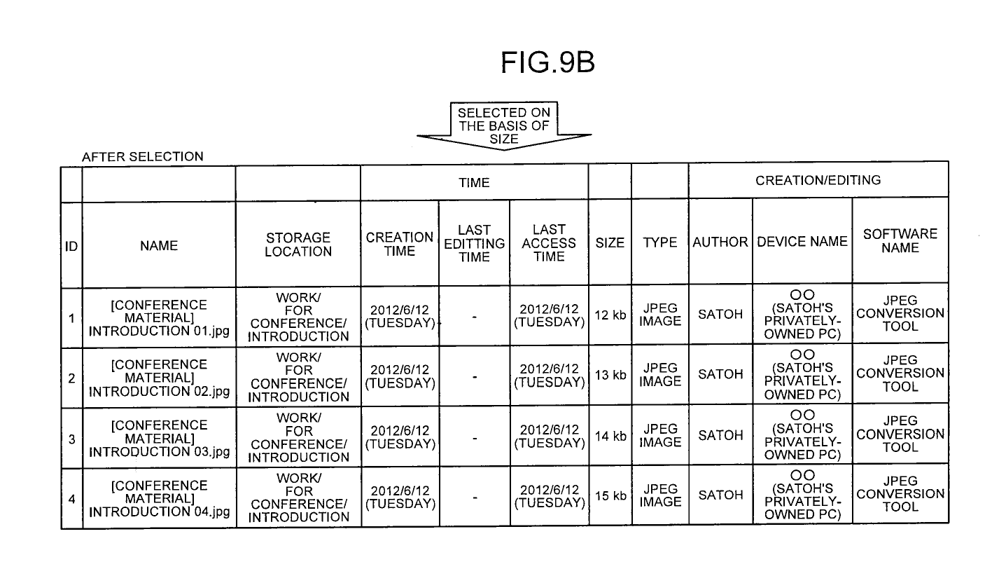

FIGS. 9A and 9B are schematic diagrams illustrating an example of the image information before and after selection when the size of the image file is specified as the selecting condition. In this example, the external storage device 20 stores therein six image files having respective attributes illustrated in the image information in the table in FIG. 9A. The selecting condition information describes the selecting condition under which the image file having the size of “1000 kb or less” is extracted to display the reduced image.

In this case, the selection unit 34 selects at least one image file on the basis of the selecting condition information including the size of the image file as the selecting condition. More specifically, the selection unit 34 selects the image files having a size of 1000 kb or less, as illustrated in the table in FIG. 9B. Thereby, the information display device 30 can remove the image file requiring a large amount of processing to generate or display the reduced image from the display target, for example, thereby making it possible to display the reduced image in a short time.

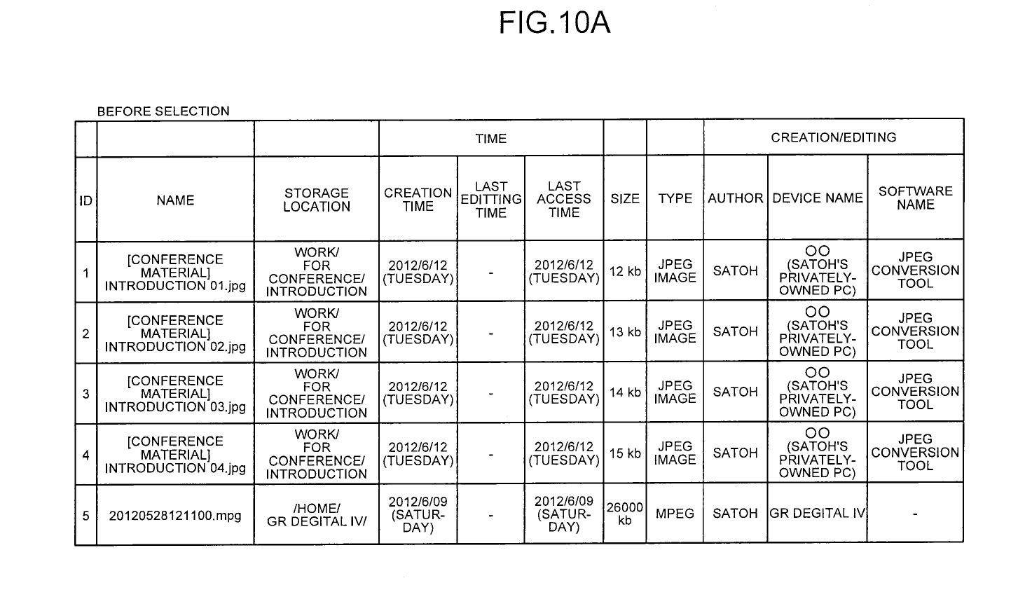

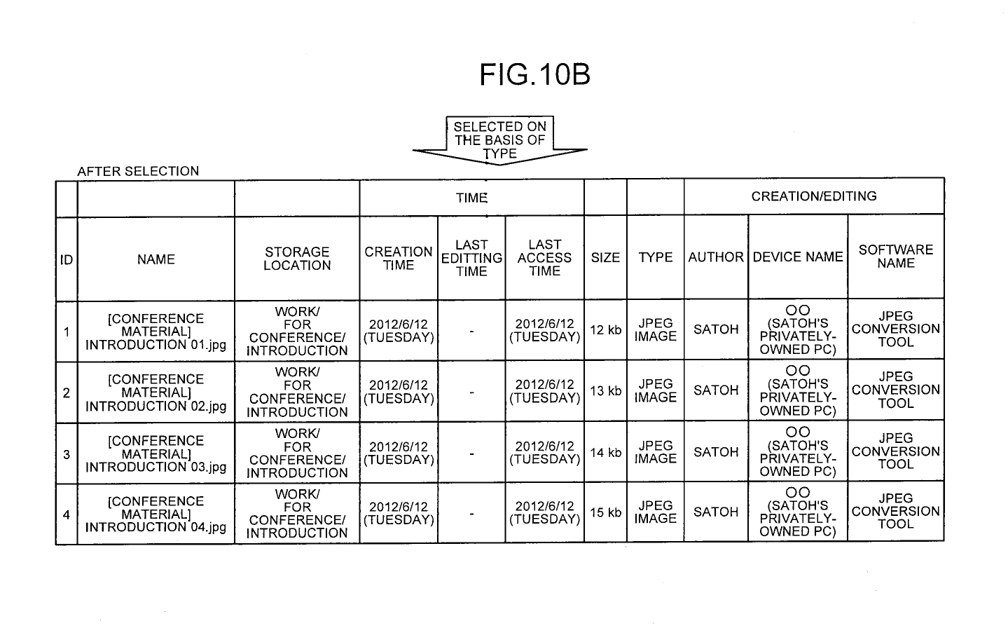

FIGS. 10A and 10B are schematic diagrams illustrating an example of the image information before and after selection when the type of the image file is specified as the selecting condition. In this example, the external storage device 20 stores therein five image files having respective attributes illustrated in the image information in the table in FIG. 10A. The selecting condition information describes the selecting condition under which the image file having the type of “JPEG” is extracted to display the reduced image.

In this case, the selection unit 34 selects at least one image file on the basis of the selecting condition information including the type of the image file as the selecting condition. More specifically, the selection unit 34 selects the image files having the type of JPEG, as illustrated in the table in FIG. 10B. Thereby, the information display device 30 displays the reduced image of the image file of a certain type created to be used for a presentation in a conference, for example, and can prohibit display of the image file created using privately owned software, for example.

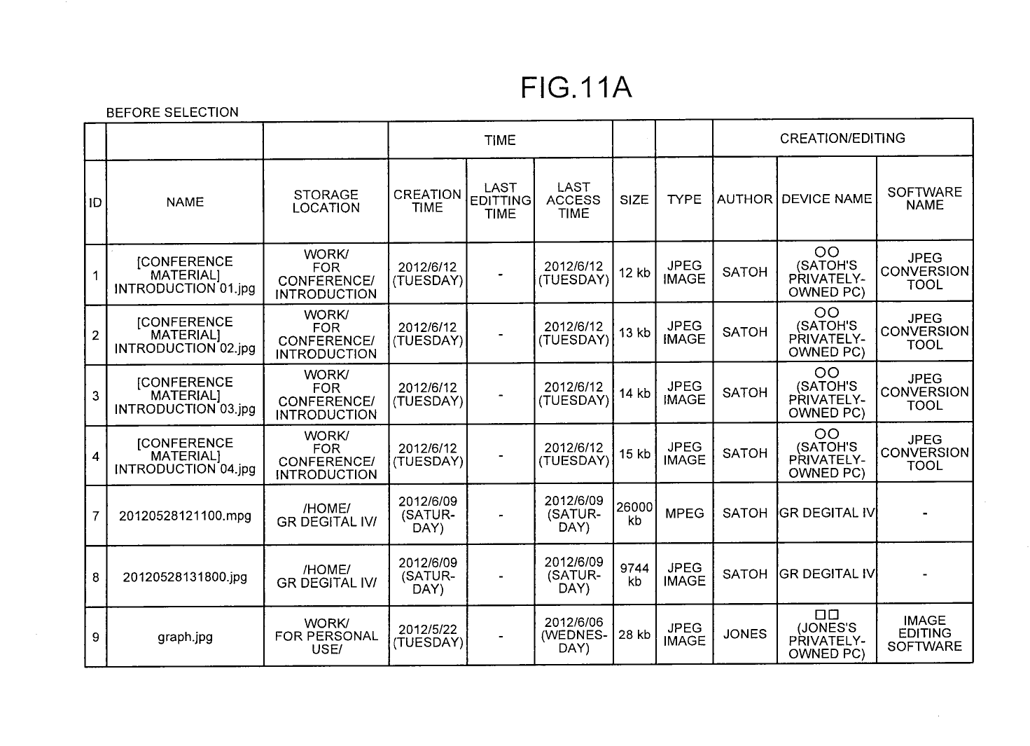

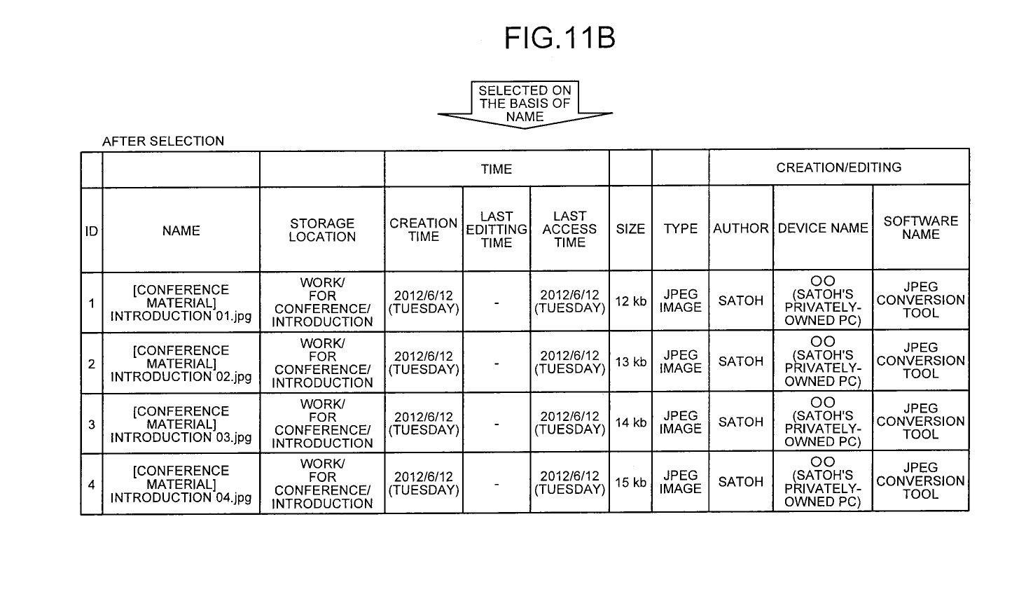

FIGS. 11A and 11B are schematic diagrams illustrating an example of the image information before and after selection when the name of the image file is specified as the selecting condition. In this example, the external storage device 20 stores therein seven image files having respective attributes illustrated in the image information in the table in FIG. 11A. The selecting condition information describes the selecting condition under which the image file having a name starting with “conference material” is extracted to display the reduced image.

In this case, the selection unit 34 selects at least one image file on the basis of the selecting condition information including the name of the image file as the selecting condition. More specifically, the selection unit 34 selects only the image files having a name starting with “conference material”, as illustrated in the table in FIG. 11B. Thereby, the selection unit 34 can display the reduced image of the image file having a name intentionally chosen for materials to be presented in a conference, for example.

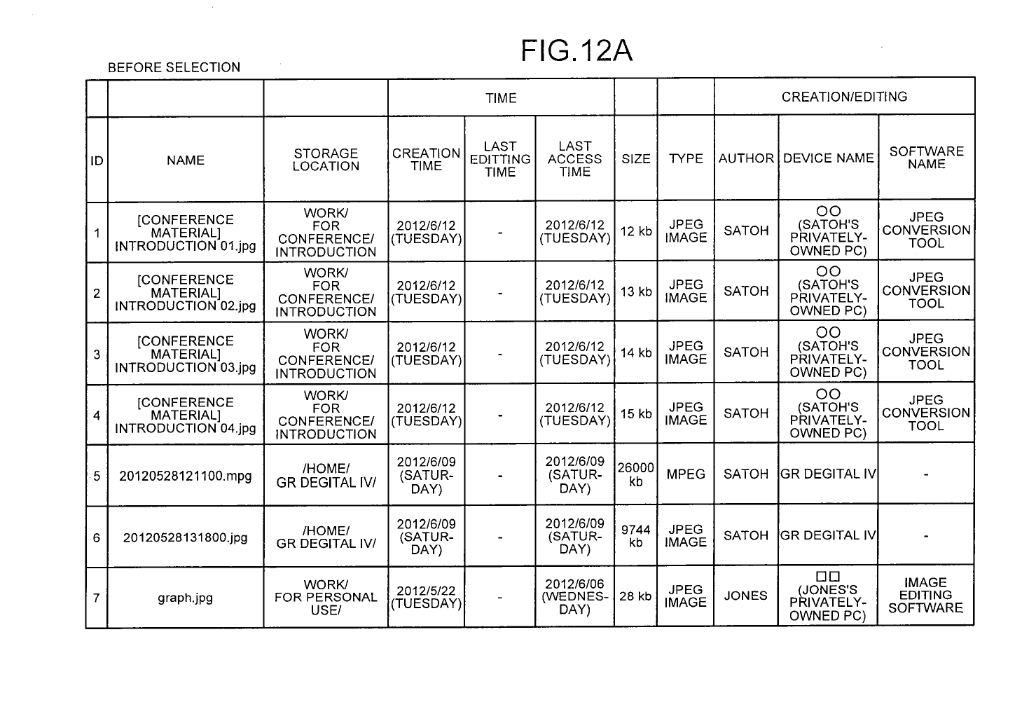

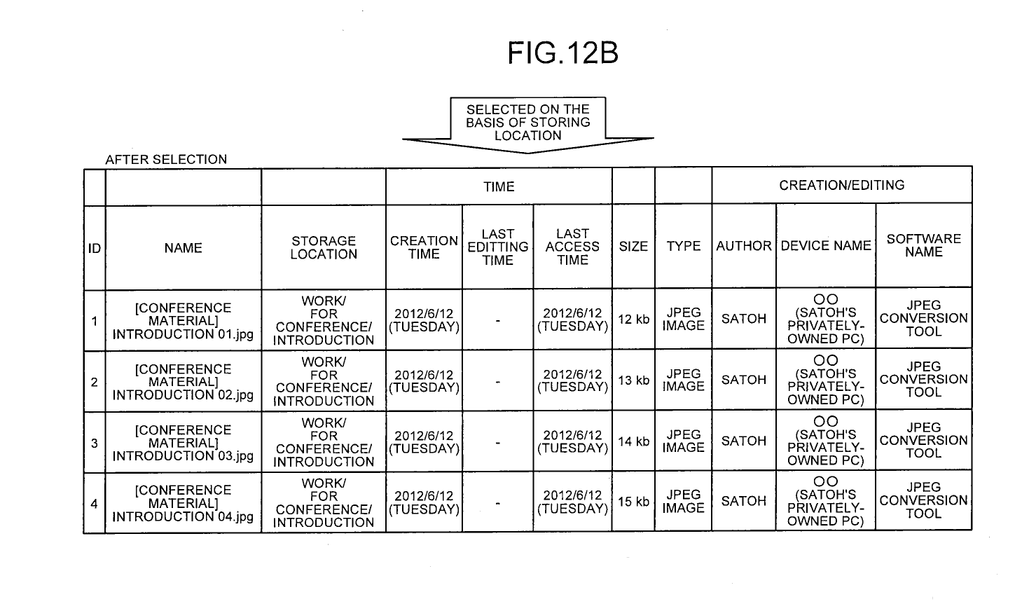

FIGS. 12A and 12B are schematic diagrams illustrating an example of the image information before and after selection when the storage location of the image file is specified as the selecting condition. In this example, the external storage device 20 stores therein seven image files having respective attributes illustrated in the image information in the table in FIG. 12A. The selecting condition information describes the selecting condition under which the image file having the storage location of the folder indicated with the path “work/for conference/introduction” is extracted to display the reduced image.

In this case, the selection unit 34 selects at least one image file on the basis of the selecting condition information including the storage location of the image file as the selecting condition. More specifically, the selection unit 34 selects only the image files having the storage location of the folder “work/for conference/introduction”, as illustrated in the table in FIG. 12B. Thereby, the selection unit 34 can display the reduced image of only the image file stored in a folder storing therein files to be presented in a conference, for example.

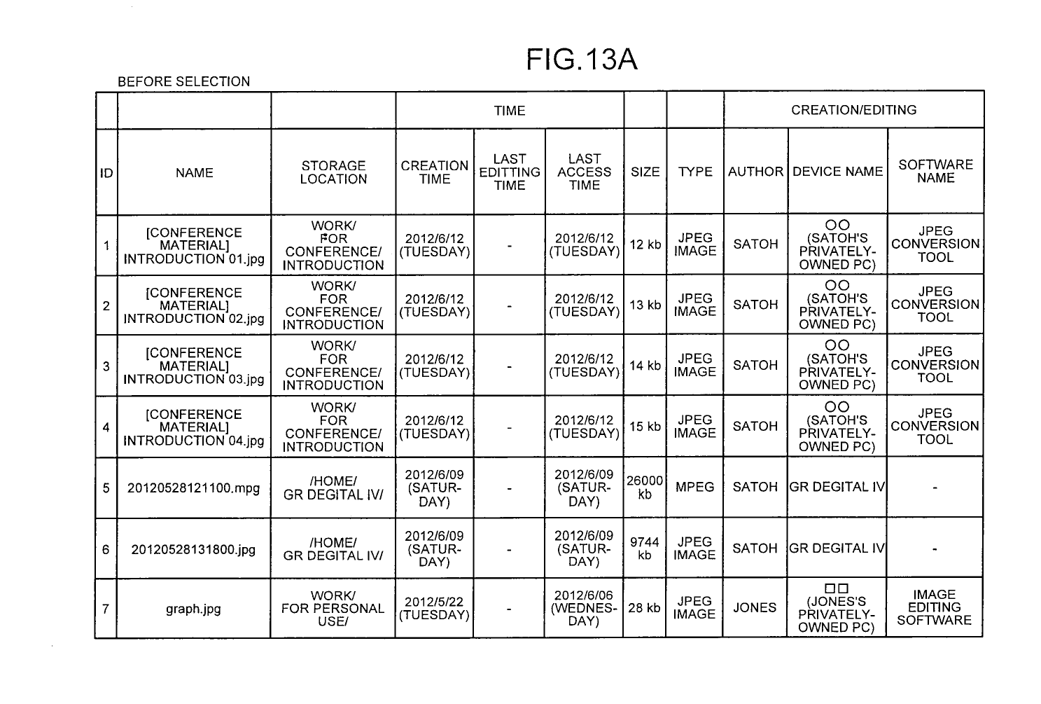

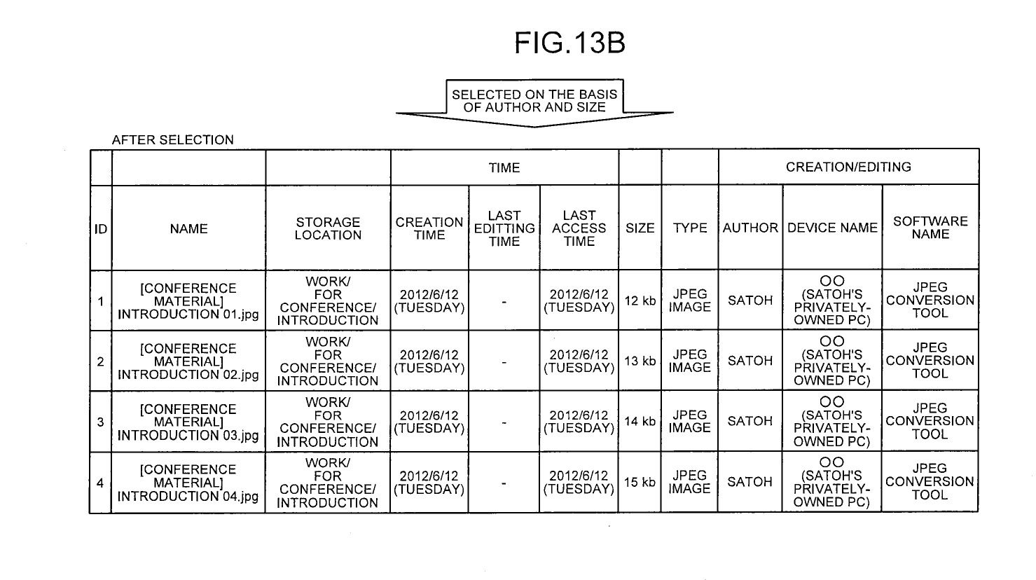

FIGS. 13A and 13B are schematic diagrams illustrating an example of the image information before and after selection when the author and the size of the image file are specified with an AND condition as the selecting condition. In this example, the external storage device 20 stores therein seven image files having respective attributes illustrated in the image information in the table in FIG. 13A. The selecting condition information describes the selecting condition under which the image file having the author of “Satoh” and the size of “1000 kb or less” is extracted to display the reduced image.

In such a case, the selection unit 34 selects at least one image file on the basis of the selecting condition information including the selecting condition in which a plurality of conditions are combined using a logical conjunction or a logical sum. More specifically, the selection unit 34 selects only the image files having the author of “Satoh” and the size of “1000 kb or less”, as illustrated in the table in FIG. 13B. Thereby, the selection unit 34 can display the reduced image of the image file selected with a condition specified in further detail.

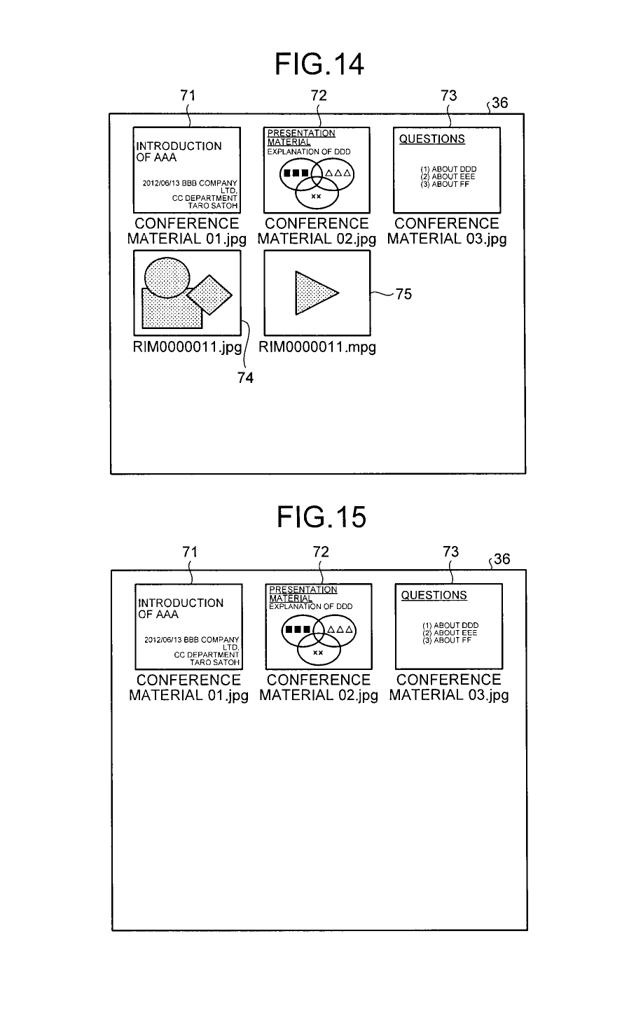

FIGS. 14A and 14B are schematic diagrams illustrating an example of a screen of the display unit 37 when the reduced images of all the image files in the external storage device 20 are displayed. FIG. 15 is a schematic diagram illustrating an example of the screen of the display unit 37 when the reduced images of the image files selected on the basis of the selecting condition information are displayed out of the image files in the external storage device 20.

A case is assumed in which the information display device 30 generates and displays the reduced images of all the image files stored in the external storage device 20 regardless of the selecting condition information upon attachment of the external storage device 20 to the information display device 30. As illustrated in FIG. 14, the information display device 30 displays reduced images 74 and 75 of privately created image files although only reduced images 71, 72, and 73 of image files of conference materials are originally intended to be displayed, for example.

The information display device 30 according to the embodiment externally acquires the selecting condition information prepared by the owner of the external storage device 20, for example, and displays only the reduced images of the image files selected in accordance with the selecting condition included in the selecting condition information. As a result, as illustrated in FIG. 15, the information display device 30 can display only the reduced images 71, 72, and 73 of the image files of the conference materials, which are originally intended to be displayed.

Thereby, the information display system 10 can appropriately select desired image files and efficiently display the reduced images of the image files. Because the owner of the external storage device 20 prepares the selecting condition information, the information display system 10 can select the image files that the owner of the external storage device 20 intends to use, and display the reduced images, even if the information display device 30 is a shared device, for example.

The program executed by the information display device 30 of the embodiment is provided by being preliminarily stored in a ROM, for example. The program may be recorded in a computer-readable recording medium as a file in an installable or executable format, and provided. Examples of the computer-readable recording medium include a compact disk read only memory (CD-ROM), a flexible disk, a CD-readable (CD-R), and a digital versatile disk (DVD).

The computer program executed by the information display device 30 of the embodiment may be stored in a computer connected to a network such as the Internet, and be provided by being downloaded through the network. The computer program executed by the information display device 30 of the embodiment may be provided or delivered through a network such as the Internet.

The computer program executed by the information display device 30 of the embodiment has a module structure including the selecting condition acquisition unit 32, the image information acquisition unit 33, the selection unit 34, the reduced image generating unit 35, and the display control unit 36. In practical hardware, the CPU reads out the computer program from the ROM and executes the computer program, so that the respective units are loaded into a main storage unit, and the selecting condition acquisition unit 32, the image information acquisition unit 33, the selection unit 34, the reduced image generating unit 35, and the display control unit 36 are formed in the main storage unit.

The embodiment provides an advantage of making it possible to display a reduced image that is selected appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display device, comprising:
a selecting condition acquisition unit that externally acquires selecting condition information including a selecting condition for selecting an image file;
a selection unit that selects at least one image file out of a plurality of image files stored in an external storage device on the basis of the selecting condition information;
a reduced image generating unit that generates a reduced image representing the at least one selected image file; and
a display control unit that causes the reduced image of each of the at least one selected image file to be displayed.

2. The information display device according to claim 1, wherein the selection unit acquires the selecting condition information from the external storage device and selects the at least one image file.

3. The information display device according to claim 1, wherein the selection unit acquires the selecting condition information from a device different from the external storage device and selects the at least one image file.

4. The information display device according to claim 1, wherein the selection unit selects the at least one image file on the basis of the selecting condition information including an author of the image file or a device with which the image file is created as the selecting condition.

5. The information display device according to claim 1, wherein the selection unit selects the at least one image file on the basis of the selecting condition information including a creation time, editing time, or access time of the image file as the selecting condition.

6. The information display device according to claim 1, wherein the selection unit selects the at least one image file on the basis of the selecting condition information including a size of the image file as the selecting condition.

7. The information display device according to claim 1, wherein the selection unit selects the at least one image file on the basis of the selecting condition information including a type of the image file as the selecting condition.

8. The information display device according to claim 1, wherein the selection unit selects the at least one image file on the basis of the selecting condition information including a name of the image file as the selecting condition.

9. The information display device according to claim 1, wherein the selection unit selects the at least one image file on the basis of the selecting condition information including a storage location of the image file as the selecting condition.

10. An information display method, comprising:
externally acquiring selecting condition information including a selecting condition for selecting an image file;
selecting at least one image file out of a plurality of image files stored in an external storage device on the basis of the selecting condition information;
generating a reduced image representing the at least one selected image file; and
causing the reduced image of each of the at least one selected image file to be displayed.

11. A computer program product comprising a non-transitory computer-usable medium having computer-readable program codes embodied in the medium, wherein the program codes when executed cause a computer to function as:
a selecting condition acquisition unit that externally acquires selecting condition information including a selecting condition for selecting an image file;
a selection unit that selects at least one image file out of a plurality of image files stored in an external storage device on the basis of the selecting condition information;
a reduced image generating unit that generates a reduced image representing the at least one selected image file; and
a display control unit that causes the reduced image of each of the at least one selected image file to be displayed.
